(19) United States
(12) Patent Application Publication
(10) Pub. No.: US 2016/0114554 A1
(43) Pub. Date: Apr. 28, 2016

(54) ANTI-SLIPPING PAD

(71) Applicant: Su-Tuan Hsu Tang, Tao-Yuan Hsien (TW)

(72) Inventor: Su-Tuan Hsu Tang, Tao-Yuan Hsien (TW)

(21) Appl. No.: 14/525,938

(22) Filed: Oct. 28, 2014

(51) Int. Cl. B32B 5/02; B32B 5/08; D06N 7/00

(52) U.S. Cl. CPC B32B 5/02; D06N 7/0092; B32B 5/08; B32B 2250/03; B32B 2307/744; B32B 2305/022; B32B 2266/0214; B32B 2307/7265

(57) ABSTRACT

An anti-slipping pad mainly fuses a braid with a shaped underlying layer and a foaming paste of a surface layer which is not shaped by way of high-temperature fusing to form an integrally covered sandwich structure. Thus, the overall material structure can be fused and is free from peeling off after a long period of time of adhering. Meanwhile, if the anti-slipping pad is applied to the bedding or scarf place mat, it can be arbitrarily placed in and cleaned by a washer or dishwasher without worrying about the peel-off problem.

### BACKGROUND OF THE INVENTION

(1) Field of the Invention

The invention relates to a method of manufacturing an anti-slipping pad, and more particularly to an integrally formed sandwich type anti-slipping pad manufactured by way of one-time foaming shaping and the glue-free technology.

(2) Description of the Prior Art

The frequently seen and widely used anti-slipping pads, such as drawer pads, table pads, cabinet pads and other pad applications, have the removable, anti-slip and non-adhesive functions, and can be used to cover articles.

There are a lot of products similar to the above-mentioned structures. For example, U.S. Pat. No. 5,863,845 provides a surface anti-slip product without the self adhesive. This product comprises a surface structure, a bottom surface structure and a top surface layer adhered to the surface structure. The overall product has the anti-slip function at least on the underlying layer structure but is not the self adhesive. The covering product comprises a surface layer adhered to the surface of the substrate. The slip-resistant substrate provides the slip-resistant property to the covering product with respect to the corresponding surface structure regardless of the parallel direction or lateral direction.

Next, U.S. Pat. No. 5,874,371 provides a plastic material braid having a top surface, a bottom surface and holes; wherein the fabric is coated with the cured slip-resistant PVC resin; and a coated and adhesive top sheet, also referred to as a top surface of a shielding member. The top surface is coated with the ink adapted to contact with the food. An anti-slip PVC resin is coated on the base layer, and at least on the bottom of the bottom surface layer.

Also, U.S. Pat. No. 6,130,174 provides an adhered product comprising a continuous ordinary flat PVC surface layer and a grid layer comprising the coated PVC foaming material, wherein the grid layer is combined with the flat surface material layer by an adhesive (glue).

Furthermore, U.S. Pat. No. 6,221,796 B1 provides an anti-slip cabinet pad product having a continuous flat vinyl plastic sheet, wherein a foaming polyvinyl chloride (PVC) plastic material sheet layer is coated on the fabric base or this is combined to the surface layer of the fabric base by an adhesive agent.

In addition, FIG. 1 shows a conventional anti-slipping pad structure, wherein the anti-slipping pad (A) can cover and can be removed and has anti-slip and non-adhesive characteristics. The technological construction comprises two manufacturing processes. The first process is to cover a well shaped fabric base (scrim) or fabric with a foaming material, to produce an anti-slip net (B) through the foaming process, and then the anti-slip net (B) is to be stacked above a substrate (D) formed by polyvinyl chloride (PVC). The second process is to use the heating adhering process with the adhesive (C) serving as a medium to permanently adhere both of them together.

According to the descriptions of the U.S. Patents and the conventional anti-slipping pad, it is not difficult to find that the anti-slip and non-self-adhesive products have been widely used by the public. However, most of all these structures of the anti-slipping pad products are to improve the conventional pad product having the adhesive backside. Thus, the conventional pad product being used cannot be easily removed or may be damaged due to the too-large adhesive force.

In the manufacturing of the pad product, an adhesive or a glue mainly serves as the combination medium between two substrates. The pad manufactured in such a way has the following drawbacks in the manufacturing processes. First, when the heated and high temperature foaming shaped anti-slip net is adhered to the underlying layer, heating, baking and drying need to be performed. However, the previously foaming shaped anti-slip net has been heated to the high temperature and thermally cured. If the heating procedure for adhering is performed, the anti-slipping pad has to be heated again to cause the coked surface and the deformation phenomenon, thereby deteriorating or losing the anti-slip ability. Second, the adhering by an adhesive tends to deteriorate the adhesive when the anti-slipping pad is placed in a high-temperature environment or used for a long period of time, so that the adhered portion has the peel-off phenomenon and the separating risk is caused. More particularly, after a long-term use and the dirtiness adhered to the surface is to be removed by way of immersion rubbing or by a washer or dryer, the ungluing and peel-off tend to occur, thereby shortening the lifetime and causing inconvenience in washing. So, this does not meet the use habit of the ordinary persons. Third, the process of adhering the foaming anti-slip net to the underlying layer together needs the second heating or high-temperature baking process to be performed on the shaped anti-slip net. So, the original anti-slip ability cannot be kept, or the anti-slip ability may be lost, thereby disabling the excellent absorptive and adhesive force from being possessed, let along providing the high performance anti-slipping pad having the better effect of the anti-slip ability. Thus, the basic anti-slip function of the pad is poor, the consumer has the few choices, and the diversified requirements of the anti-slip absorbing function of the modern users cannot be satisfied.

In view of this, the present inventor has paid attention to the research and development according to the experience and the technology in manufacturing the associated products for many years, and thus developed a creative structure of an anti-slipping pad to effectively solve the problem and further to achieve the more diversified use effectiveness.

### SUMMARY OF THE INVENTION

A main object of the invention is to provide an anti-slipping pad, and more particularly a sandwich type anti-slipping pad, in which a braid is clamped at the middle by way of integral foaming shaping, wherein the drawback of the separation risk of the conventional product formed by way of adhering can be eliminated.

Another object of the invention is to provide anti-slipping pads having different degrees of anti-slip effects or adhesive forces so that the consumers can freely apply the anti-slipping pads to a dry surface, a wet surface, an inclined surface and a vertical surface.

Still another object of the invention is to provide an anti-slipping pad having surface patterns that can be freely controlled to be diversified.

Yet still another object of the invention is to provide an anti-slipping pad so that the constituted sandwich anti-slipping pad has different color layers, and the overall product is rich in the visual aesthetic feelings and creativity.

To achieve the above-identified objects, the invention provides an anti-slipping pad, comprising: a braid; a shaped underlying layer disposed below the braid; and a foaming paste of a surface layer which is not shaped disposed above the braid, so that an integrally covered sandwich structure is formed by way of high-temperature fusing.

The braid is selected from a group consisting of artificial silk, hemp, cotton and other wovens.

The foaming paste and the underlying layer are made of the same material, which is selected from one of the group consisting of polyvinyl chloride (PVC), polymer environment resin (PER), vinyl ester resin (EVA), nitrile butadiene rubber (NBR), styrene butadiene rubber (SBR), silicone and acrylic

The underlying layer has a waterproof effect, and has a surface on which textures, colors or patterns may be printed.

The foaming paste is shaped to have patterns comprising regular strip-like patterns, dotted patterns, texture-like patterns or single-film patterns.

The braid, foaming paste, underlying layer may be added with different colors for distinguishing, so that the shaped anti-slipping pad further has the visual aesthetic feeling.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 shows a conventional anti-slipping pad structure.

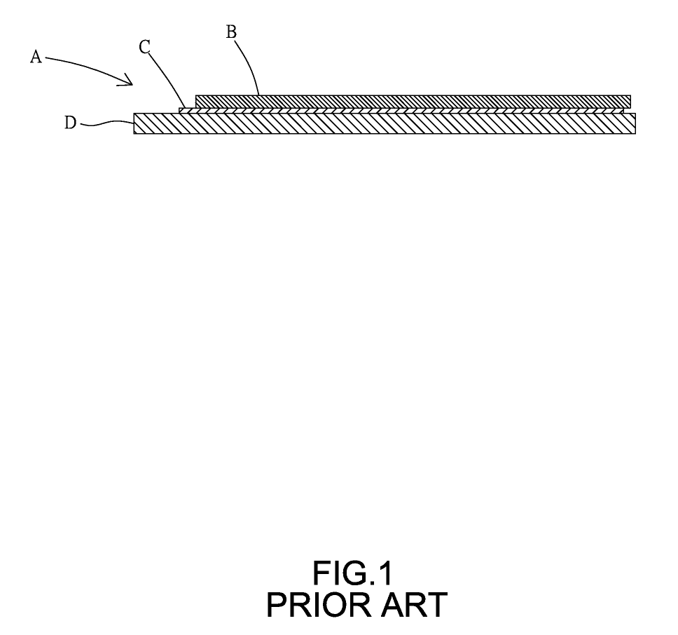

FIG. 2 is a flow chart showing manufacturing of the invention.

FIG. 3 is a schematic view showing a system arrangement of manufacturing the invention.

FIG. 4 is a schematic view showing the anti-slipping pad material laminating of manufacturing the invention.

FIG. 5 is a schematic view showing an anti-slipping pad structure of the invention.

FIG. 6 is a schematic view showing another pattern of the anti-slipping pad of the invention.

### DETAILED DESCRIPTION OF THE PREFERRED EMBODIMENTS

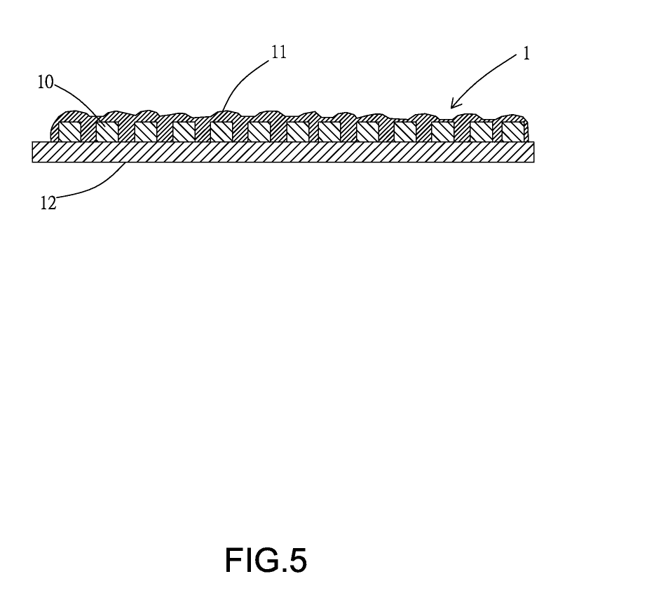

FIG. 5 shows an anti-slipping pad 1, wherein a braid 10 is disposed above an underlying layer 12, and a foaming paste 11, which is not shaped, is baked. Thus, the foaming paste 11 is heated and then flows to the surface of the underlying layer 12 through the braid 10, and then combined together to form a sandwich structure through the high-temperature foaming action. The foaming paste 11 on the surface of the sandwich structure has the anti-slip function, and the underlying layer 12 on the bottom surface may have the waterproof function.

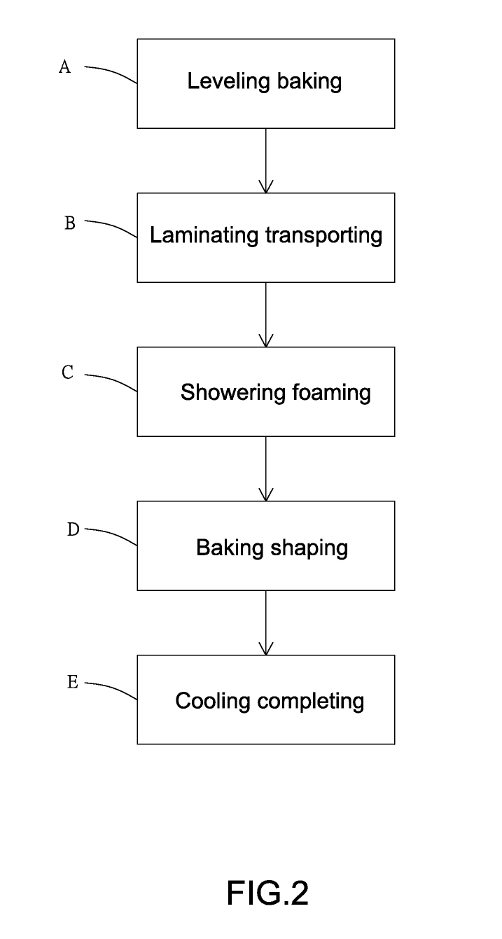

Referring to FIG. 2, a method of manufacturing the anti-slipping pad according to the invention comprises the steps of: (A) leveling baking; (B) laminating transporting; (C) showering foaming; (D) baking shaping; and (E) cooling completing.

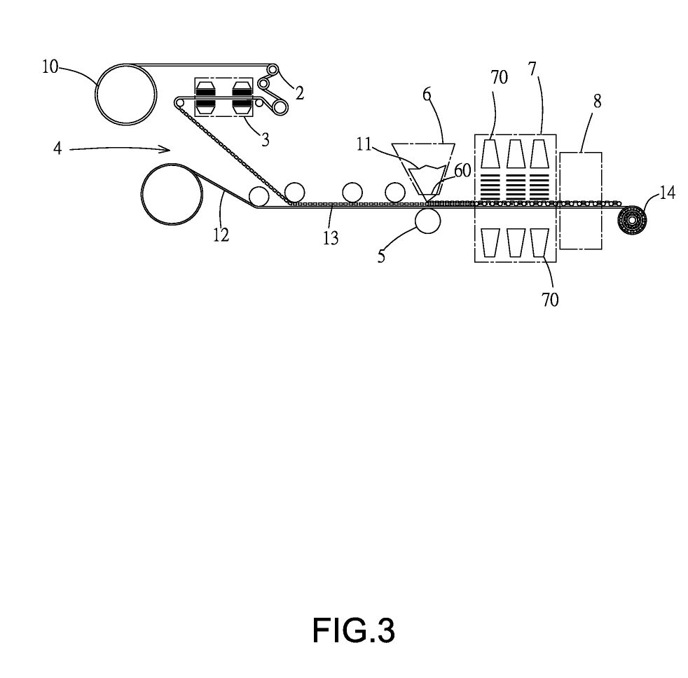

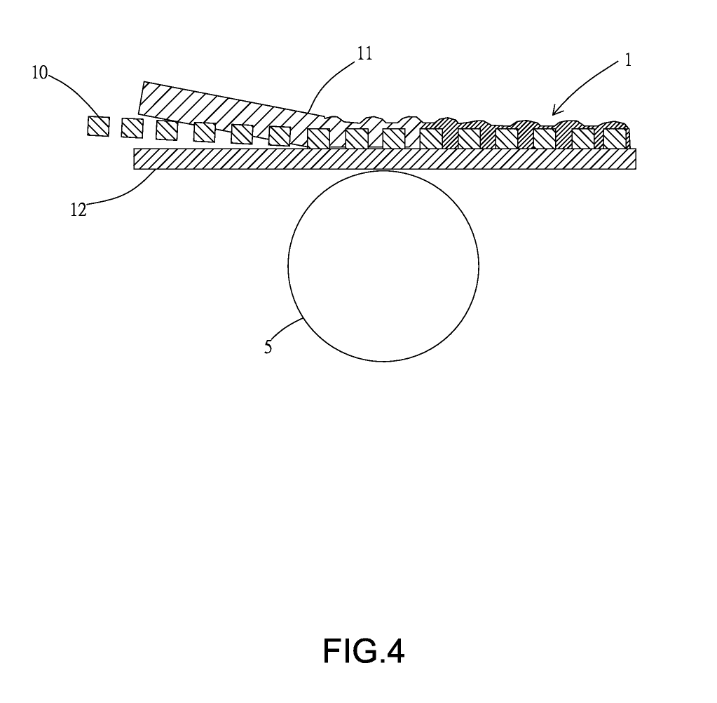

Referring to FIGS. 2 to 4, the required system arrangement according to the above-mentioned method comprises: an expanding roller 2 for spreading and leveling the braid 10; a high-temperature oven 3 for removing moisture from the braid 10 and shaping the braid 10 so that the braid 10 cannot be easily retracted; a transportation device 4 for pressing the braid 10 against the underlying layer 12 to form a laminated structure 13, and then transporting the laminated structure 13; a material showering platform 5, above which a funnel 6 is disposed, wherein the material showering platform 5 showers the foaming paste 11 over the laminated structure 13 formed by the braid 10 and the underlying layer 12; a foaming furnace 7 for providing a heating function to fuse the foaming paste 11 and the underlying layer 12 into a sandwich structure; and a cooling device 8 for providing a cooling function to cool the sandwich structure into a compacted solid.

In the leveling baking step (A) of this method, the braid 10 is spread and leveled through the expanding roller 2, and then enters the high-temperature oven 3, in which the moisture is removed and the braid 10 is shaped.

In the laminating transporting step (B) of this method, the transportation device 4 transports the leveled braid 10 and the underlying layer 12 and presses the braid 10 against the underlying layer 12 to form an adhered laminated structure 13, and transports the adhered laminated structure 13 to the material showering platform 5.

In the showering foaming step (C) of this method, the foaming paste 11 is showered over the laminated structure 13 moving past the material showering platform 5, wherein the funnel 6 is disposed above the material showering platform 5, and the prepared foaming paste 11 is showered over the surface of the laminated structure 13 and flows to the top of the underlying layer 12 through the gaps of the braid 10 according to the liquidity of the foaming paste 11.

The funnel 6 has an opening 60. The opening 60 can be used in conjunction with the control method to shower the foaming paste 11 over the laminated structure 13 in different manners to form patterns comprising regular lines, such as strip-like lines or dotted lines.

In addition, as the prepared amount of the foaming paste 11 gets fewer, the density gets lower, and the relative anti-slip ability gets lower.

As the prepared amount of the foaming paste 11 gets more, the density gets higher, and the relative anti-slip ability gets higher.

In the baking shaping step (D) of this method, the laminated structure 13 showered with the foaming paste 11 is transported into the foaming furnace 7 through the transportation device 4. The foaming furnace 7 has upper and lower heating devices 70, and has the temperature which can reach 200° C. In order to prevent the shaped underlying layer 12 from being melted and damaged by the high temperature when the upper and lower heating devices heat concurrently, only the upper heating device 70 is used to bake the foaming paste 11. After a suitable period of time is elapsed and the temperature control is performed, the foaming paste 11 can be softened and combined with the softened contact surface of the underlying layer 12. Because the foaming paste 11 and the underlying layer 12 are made of the same material, they can be fused together while clamping the braid 10 thereinbetween to form a sandwich structure.

In the cooling completing step (E) of this method, the transportation device 4 further transports the combined sandwich structure to the cooling device 8 to perform the cooling to change from the fused state to a compacted solid state.

The cooled semi-facture 14 formed after the final cooling completing step (E) can be retracted by a retractor. In practice, the required suitable size can be cut according to the usage and the requirements for different applications, such as bedding, place mat, scarf and the like.

Comparing the invention with the prior art, the anti-slipping pad of the invention and the structure of the anti-slipping pad of the prior art have different structures and manufacturing methods. The conventional method produces the anti-slip net by way of foaming process, and then utilizes the heating adhering process to adhere the printed sheet to the anti-slip net, while the invention directly finishes the facture with the same functionality using one foaming process. So, the prior art uses two processes, while the invention uses only one process. So, the manufacturing method of the invention improves the drawback of the prior art in the aspect of energy saving and carbon reduction.

Regarding the anti-slipping pad 1 of the invention, the prepared density of the foaming paste 11 relates to the used amount, so that different anti-slipping pads with different anti-slip abilities can be produced.

If the low anti-slip requirement is needed, the foaming paste 11 can be adjusted to the low density and the low usage amount. On the contrary, if the anti-slip requirement is high, the foaming paste 11 can be adjusted to have the high density and the high usage amount, and the diversified requirements of the anti-slip ability function for the users can be satisfied in conjunction with the paste properties of different materials.

The anti-slipping pad 1 of the invention can achieve different degrees of anti-slip abilities. The key point is to control the density and the usage amount of the foaming paste 11, so that the anti-slipping pads 1 comprising the suitable adhesive property, the middle adhesive and absorptive property, the completely non-adhesive property and the like can be produced. The surface of the anti-slipping pad 1 may have different degrees of absorptive and adhesive forces or have no absorptive and adhesive force, and the anti-slipping pad 1 can be easily removed without leaving trace, wherein the suitable adhesive property represents the placement on the ordinary plane, such as the usage of the table pad or cabinet pad; the middle adhesive property represents the adhesive placement on the inclined surface or even the reversely inclined surface, such as the placement on the window, toilet bowl pad and windshield; and the completely non-adhesive property replacement represents the use requirement of the non-adhesive or anti-slip requirement, such as the placement of the place mat, game pad or the like.

The anti-slipping pad 1 of the invention is different from the typical anti-slipping pad in that the invention adopts the integral forming technology of one-time high-temperature heating to make the shaped underlying layer 12 and the unshaped surface foaming paste 11 be combined together through the high-temperature foaming, so that the firm single organization is formed without the prior art adhering process using the adhesive. No exclusion occurs after a long period of time due to the different materials and properties of the adhesive, the surface layer and the underlying layer, and no peel-off risk is accelerated when the product enters the high-temperature environment or is washed. Also, the anti-slipping pad 1 is a soft pad and has the structure formed by way of foaming to become a single organization. For the dirtiness adhered to the surface, the soft pad can be rubbed or washed by the washer or dryer without the ungluing and peel-off phenomena. So, the cleaning can be performed extremely conveniently, and the lifetime can be lengthened.

The braid 10, foaming paste 11 and underlying layer 12 of the anti-slipping pad 1 of the invention may be implemented by various materials. The braid 10 may be made of the artificial silk, hemp, cotton or other wovens with the same kind. The materials of the foaming paste 11 and the underlying layer 12 may be polyvinyl chloride (PVC), polymer environment resin (PER), vinyl ester resin (EVA), nitrile butadiene rubber (NBR), styrene butadiene rubber (SBR), silicone or acrylic.

As mentioned hereinabove, the underlying layer 12 may have the water-absorbing effect, and the surface made of artificial fiber or polyester, nylon, cotton, hemp or any woven.

The anti-slipping pad of the invention can be manufactured according to the property of each material to form the sandwich structure with the anti-slip property, without the anti-slip property, with the soft and adhesive (absorptive) property or the incapability of easy removal (high absorptive) property, and the surface has different degrees of absorptive and adhesive forces or has no absorptive and adhesive force, and can be easily removed without leaving any trace. The suitable adhesive property represents the placement on the ordinary plane, such as the usage of the table pad or cabinet pad; the middle adhesive property represents the adhesive placement on the inclined surface or even the reversely inclined surface, such as the placement on the window, toilet bowl pad and windshield; and the completely non-adhesive property replacement represents the use requirement of the non-adhesive or anti-slip requirement, such as the placement of the place mat, game pad or the like. This is the maximum added value of the invention.

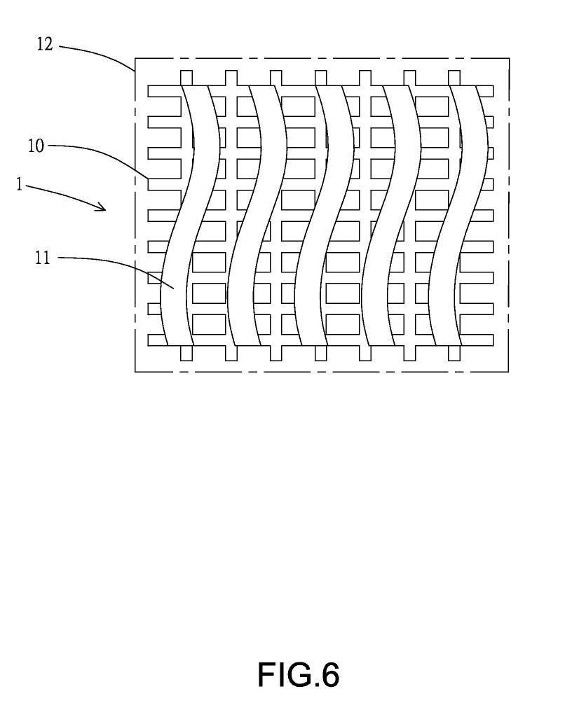

Referring to FIG. 6, in addition to the applications of different materials to manufacture the anti-slipping pads 1 with multiple anti-slip effects, the invention can manufacture more lively and diversified surface textures or color layers having more visual effects. The underlying layer 12 has the waterproof effect due to the material property, and has the surface on which various textures, colors, patterns and the like can be selectively printed. In addition, the rotating material roller is disposed on the material showering platform 5 and works in conjunction with the control action of the opening 60 of the funnel 6 to perform various showering operations, so that the foaming paste 11 is showered over the surface pattern of the braid 10 of the laminated structure 13 to form patterns comprising regular strip-like patterns, dotted patterns, texture-like patterns or single-film patterns.

In addition, in the anti-slipping pad 1 of the invention, each layer of material structure in the shaped sandwich structure may be differently colored in the manufacturing processes for the sake of distinguishing, so that the constructed sandwich anti-slipping pad has different color layers at the same time, and the overall product is rich in the visual aesthetic feelings and creativity.

In summary, the invention particularly utilizes the same material in conjunction with a shaped underlying layer, and a surface layer, which is not shaped, to cover and clamp a braid to constitute a creatively integrally formed sandwich structure. Meanwhile, more integrally formed anti-slipping pads with different usages can be made according to the requirement of the anti-slip effect. Compared this invention with the prior art, in which the semi-facture is formed and then the gluing process is performed, the invention only needs one foaming process to direct finish the adhering process without the gluing and the two manufacturing processes. This method can form the anti-slip surface having the strengthened structure, and the attached dirtiness can be vigorously washed without the peel-off phenomenon. The facture thereof can be cut into the suitable size applied to the bedding, place mat or scarf. The method of the invention improves the technology that cannot be achieved by the prior art, and can shorten the working time, decrease the energy consumption and achieve the environment protection and carbon reduction objects.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. An anti-slipping pad, comprising:
a braid;
a shaped underlying layer disposed below the braid; and
a foaming paste of a surface layer which is not shaped disposed above the braid, so that an integrally covered sandwich structure is formed by way of high-temperature fusing.

2. The anti-slipping pad according to claim 1, wherein the braid is selected from a group consisting of artificial silk, hemp, cotton and other wovens.

3. The anti-slipping pad according to claim 1, wherein the foaming paste and the underlying layer are made of the same material, which is selected from one of the group consisting of polyvinyl chloride (PVC), polymer environment resin (PER), vinyl ester resin (EVA), nitrile butadiene rubber (NBR), styrene butadiene rubber (SBR), silicone and acrylic

4. The anti-slipping pad according to claim 1, wherein the underlying layer has a waterproof effect, and has a surface on which textures, colors or patterns may be printed.

5. The anti-slipping pad according to claim 1, wherein the underlying layer has a water-absorbing effect, and has a surface made of artificial fiber, polyester, nylon, cotton, hemp or wovens. The anti-slipping pad according to claim 1, wherein the foaming paste is shaped to have patterns comprising regular strip-like patterns, dotted patterns, texture-like patterns or single-film patterns.
